(19) United States
(12) Patent Application Publication
(10) Pub. No.: US 2005/0057583 A1
(43) Pub. Date: Mar. 17, 2005

(54) Display device, method of driving the same, and projection display device

(75) Inventor: Hidehito Iisaka, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/911,668

(22) Filed: Aug. 5, 2004

(30) Foreign Application Priority Data
Aug. 12, 2003 (JP) 2003-292136
May 31, 2004 (JP) 2004-161187

(51) Int. Cl. G09G 5/02; G09G 5/00; G09G 3/36

(52) U.S. Cl. 345/694; 345/698; 345/3.3; 345/104

(57) ABSTRACT

Aspects of the invention can provide a display device capable of performing a multiple speed scanning without using a high capacity memory. The liquid crystal display device according to the invention can include a memory having a half capacity of display pixel, and image signals input from the outside are written into the pixel as first field data. Second field data delayed with respect to the first field data is generated by reading the image signals after storing the image signals in the data storage device. The first field data and the second field data are written alternately into the pixels connected to the scanning lines to which the pulse signals are supplied while interleaving every horizontal period.

### BACKGROUND OF THE INVENTION

1. Field of Invention

The invention relates to a display device and a method of driving the same.

2. Description of Related Art

In related display devices, such as liquid crystal display devices, it is impossible to select a driving method to prevent the occurrence of flicker. For example, the afterglow of fluorescent substance is commonly generated in CRTs such that images in a first field and a second field are interlaced-scanned (interlace driven) to be composed as one image on the tube surface. However, since the cycle of the flicker is only about 17 ms, there is no noticeable problem in viewing the images. But, when the liquid crystal display devices are driven in the same manner as the CRTs, since inversion is performed in the liquid crystal display devices, the n-th scanning line is selected from the first field, is not selected from the second field. Rather, the (n+1)th scanning line adjacent to the n-th scanning line is selected from the second field. In other words, since every scanning line is selected from each other field, the period of flicker is long as 33 ms in a two-frame interval (an image signal having the same polarity is once written in two frames to form a flicker), which is too long to obtain a clear visibility.

Accordingly, a liquid crystal display device, to which the image signal corresponding to the scanning line of the first field and the subsequent image signal corresponding to the scanning line of the second field, which is an image signal corresponding to the scanning line of the first field, are input, and which includes a first memory that stores the image signal corresponding to the scanning line of the first field and a second memory that stores the image signal corresponding to the scanning line of the second field has been disclosed. According to the related liquid crystal display device, the image signal for a frame can be stored in the first and second memories, and the image signal is read in one horizontal period reduced to ½ such that the image for two-field intervals of the interlaced scanning can be converted into a line sequential scanning image for a frame interval (about 17 ms). According to this scanning method, it is possible to display images without generating flicker.

### SUMMARY OF THE INVENTION

However, when the inversion interval of liquid crystal and a display pattern coincide with each other, flicker may be visible. According to such a method, two memories having a capacitor capable of storing the image signal for each field are required. Thus, the structure of the liquid crystal display becomes complicated and the manufacturing cost of the liquid crystal displays increases. Here, the liquid crystal display device is taken as an example. However, according to another display device, such as an electro-luminescent (EL) display device, such a scanning method is effective in improving the brightness of an image or in reducing power consumption. In this case, as long as the related technology is used, two memories having a large capacity are required such that the structure of the liquid crystal display device becomes also complicated, which consequently increase the manufacturing cost.

An aspect of the invention can provide a display device using the above-described scanning method without high capacity memories and a method of driving the same. In order to achieve this object, a display device according to the invention can include a plurality of data lines and a plurality of scanning lines which intersect each other, pixels connected to the plurality of data lines and a plurality of scanning lines, a data-line driving circuit for supplying, to the plurality of data lines, image signals whose polarities are inversed between positive potential and negative potential with respect to a predetermined potential at predetermined intervals, and a scanning-line driving circuit for supplying, to the plurality of scanning lines, pulse signals which are generated at different time intervals for one horizontal period, while interleaving some parts of the plurality of scanning lines. The data-line driving circuit can include a data storing device that is capable of storing input data for a specified period, and the data-line driving circuit writes image signals input from outside into the pixels as first field data, generates second field data delayed with respect to the first field data, by reading the image signals after storing the image signals into the data storing device, and writes alternately the first field data and the second field data in the pixels connected to the scanning lines to which the pulse signals are supplied while interleaving for every horizontal period.

The data line driving circuit in the display device according to the invention outputs image signals whose polarities are inversed with respect to predetermined potential at predetermined intervals. On the other hand, the scanning driving circuit does not perform line sequential scanning from the upper portion of a screen to the lower portion of a screen, but performs scanning with respect to all of the scanning lines while a part (plural) of scanning lines is interleaved and gone back and forth. Based on the operation of the driving circuits, pulse signals generated at different time intervals are supplied to the respective scanning lines.

Further, according to the invention, the data-line driving circuit supplies image signals whose polarities are inversed between positive potential and negative potential with respect to a predetermined potential every two horizontal periods. The scanning line driving circuit supplies the plurality of pulse signals to the plurality of data lines while interleaving the part of the plurality of scanning lines such that the image signals which have an inversed polarity are written into the pixels connected to the adjacent scanning lines, and performs line-inversion driving. In the meantime, in the scanning line driving circuit, since two scanning lines of the screen is alternatively selected, images are written in two regions of the screen.

In other words, according to this structure, while image data is written in every line by an outside image signal, it is possible to write images by the image data read from the data storage means at multiple speed (by a frequency twice the frequency of the image signal input from the outside). In a conventional technology, when a multiple speed scanning is performed, memories for two fields are required. However, according to this structure, since the image signal from the outside is output to the data lines using the data storage means to write the half of the screen, the data storage capacitor may amount only the half of the entire display screen. Thus, the data storage capacitor may amount only ¼ of the conventional data storage capacitor such that it is possible to simplify the structure of the display device and to significantly reduce the manufacturing cost of the display devices. According to the display device of the present structure, since the multiple speed scanning is performed with respect to pixels, when the same is applied to a liquid crystal display device, it is possible to prevent the generation of flicker.

Specifically, the data line driving circuit supplies an image signal whose polarity is inverted from positive polarity potential to negative polarity potential with respect to a predetermined potential to each of the plurality of data lines every two-horizontal periods. The scanning line driving circuit supplies a plurality of pulse signals to the plurality of scanning lines while interleaving some part of the plurality of scanning lines such that image signals having different polarities are written in the pixels connected to adjacent scanning lines. According to this structure, since the line inversion driving is performed while performing the multiple speed scanning, it is possible to display images with excellent uniformity.

To be more specific, when the number of scanning lines is 2m, the scanning line driving circuit supplies the pulse signal generated at the timing corresponding to an interval in which the positive polarity potential is applied to a predetermined scanning line, supplies the pulse signal generated at the timing corresponding to the interval in which the positive polarity potential is applied to the scanning line separated from the predetermined scanning line by m, supplies the pulse signal generated at the timing corresponding to an interval in which negative polarity potential is applied to the scanning line next to the predetermined scanning line, supplies the pulse signal generated at the timing corresponding to the interval in which the negative polarity potential is applied to the scanning line remote from the scanning line next to the predetermined scanning line by m, and repeats the above-described operations such that the image signals having different polarities are written in the pixels corresponding to the adjacent scanning lines.

For example, the writing time of second field data is delayed by ½ of a vertical period from the writing time of the input of first field data. In this case, while the image for the half upper portion of a screen is output to the data lines by the image signal input from the outside, the image data for the half upper portion of the screen is output to the data storage means (for example, a memory) to be stored in the data storage means. While the image for the half lower portion of the screen is output to the data lines by the image signal, the image data prior to ½ of the vertical period (that is, the image data for the half upper portion of the screen) is output from the memory to the data lines. The data from the outside and the memory is alternately output to the data line every horizontal period. On the other hand, since the scanning line on the upper end of the screen and the scanning line on the lower end of the screen are alternately selected every horizontal period, an image is alternately written between the upper end of the screen and the lower end of the screen. In other words, according to this structure, while an image is written from the image signal input from the outside for every line, an image is written by the image data read from the memory at multiple speed (by a frequency twice the frequency of the image signal input from the outside).

When attention is paid to the scanning line driving circuit of the display device according to the invention, the present display device may be characterized as follows. That is, according to the invention, the scanning line driving circuit alternately shifts two gate output pulses to adjacent scanning lines by synchronizing with a shift clock signal, and assigns one of the two alternately generated enable signals to each scanning line such that the output of the scanning signals to the respective scanning lines is controlled.

According to this structure, the two gate output pulses are generated in different scanning line positions in the image display region and are shifted from the upper end of an image display region to the lower end of the image display region by synchronizing with the shift clock signal. The scanning signals are output to the scanning lines selected by the enable signals among the signal lines in which the gate output pulses are generated. Thus, it is possible to scan the scanning lines such that some parts of (a plurality of) the scanning lines are interleaved.

Specifically, while the two gate output pulses are output to the scanning line driving circuit so as to be separated from each other by a distance corresponding to ½ of the vertical period, one of the first enable signal and the second enable signal that are alternately generated can be assigned to each scanning line. Thus, when the image display region is divided into a first display region and a second display region from the upper end in the direction in which the scanning lines are arranged, the respective enable signals can be assigned to the plurality of scanning lines arranged in any one of the first and second display regions, such that the scanning signals can be alternately output to the scanning line that belongs to the first display region and to the scanning line that belongs to the second display region corresponding to the position where each enable signal is generated.

According to this structure, the two gate output pulses are generated in the positions that deviate from each other by ½ of the screen such that the gate output pulses are shifted from the upper end of the image display region to the lower end of the image display region by synchronizing with the clock signal. The scanning signals are output to the scanning lines selected by the enable signals in which the gate output pulses are generated. At this time, since the first enable signal can be assigned to the first display region and the second enable signal can be assigned to the second display region, the scanning line on the upper end of the image display region and the scanning line on the lower end of the image display region are alternately selected. Thus, it is possible to perform scanning on all of the scanning lines from the upper end of the image display region to the lower end of the display region by interleaving the scanning lines for ½ of the screen.

While the scanning driving circuit outputs the two gate output pulses to the position where they are separated from each other by the distance corresponding to ½ of the vertical period, one of the first enable signal and the second enable signal that are alternately generated can be assigned to each scanning line such that the first enable signal and the second enable signal can be assigned to the odd numbered scanning lines and to the even numbered scanning lines, respectively, from the leftmost portion of the image display region. Thus, when the image display region is divided into the first display region and the second display region from the upper end in the direction in which the scanning lines are arranged, the scanning signals are alternately output to the scanning line that belongs to the first display region and to the scanning line that belongs to the second display region corresponding to the starting position of each enable signal.

According to a method of driving a display device comprising a plurality of data lines and a plurality of scanning lines that intersect each other and pixels connected to the data lines and the scanning lines, image signals whose polarities are inversed between positive polarity potential and negative polarity potential with respect to predetermined potential are supplied to the plurality of data lines at predetermined intervals. A plurality of pulse signals generated at different timings are supplied to the plurality of scanning lines every horizontal period while interleaving part of the plurality of scanning lines. The image signals input from the outside are written in the pixels using data storage means for storing input data for a specified time as first field data. The image signals are stored in the data storage means and are read such that second field data delayed with respect to the first field data is generated. The first field data and the second field data are alternately written in the pixels connected to the scanning lines, to which the pulse signals are supplied, while interlacing the scanning lines every horizontal period.

According to the method of driving the display device of the invention, it is possible to obtain the same operation and effect as those of the display device of the present invention. In other words, according to this structure, while the image data is written by the image signals from the outside for every line, images are written by the image data read from memories that are data storage means. Thus, it is possible to write images at multiple speed. As a result, according to the present structure, it is possible to reduce the capacitor of the memories compared to the conventional common memories such that it is also possible to simplify the structure of the display device and to significantly reduce the manufacturing cost of the display devices.

Also, it is possible to perform interlaced scanning of the scanning lines in a vertical period by a frequency no less than 100 Hz. Thus, it is possible to avoid the flicker caused by the difference in polarities of the pixels.

### BRIEF DESCRIPTION OF THE DRAWINGS

The invention will be described with reference to the accompanying drawings, wherein like numerals reference like elements, and wherein:

FIG. 1 is a schematic structure view of a liquid crystal display device according to a first exemplary embodiment;

FIG. 2 is a cross-sectional view taken along the line H-H′ of FIG. 1;

FIG. 3 is an equivalent circuit diagram showing a plurality of pixels in a matrix which forms the liquid crystal display device;

FIG. 4 is an exemplary block diagram including a driving circuit;

FIG. 5 is an exemplary circuit diagram showing a structure of a scanning line driving circuit;

FIG. 6 is an exemplary specific circuit diagram of essential parts shown in FIG. 5;

FIG. 7 is a timing chart for explaining an operation of the liquid crystal display device;

FIG. 8 is a timing chart about essential parts;

FIG. 9 is a view for explaining a motion in a screen;

FIG. 10 is a structure view of inside of a controller;

FIG. 11 is an exemplary circuit diagram showing the structure of a scanning driver in the driving circuit of the liquid crystal display device according to the second exemplary embodiment of the invention;

FIG. 12 is an exemplary detailed circuit diagram showing an essential part of FIG. 11;

FIG. 13 is a timing chart for explaining the operation of the liquid crystal display device; and

FIG. 14 is a schematic structure view showing an example of a projection display device using the liquid crystal device of the invention.

### DETAILED DESCRIPTION OF PREFERRED EMBODIMENTS

Hereinafter, a first exemplary embodiment of the invention will be described with reference to the accompanying drawings FIG. 1 to FIG. 10. In this embodiment, a liquid crystal display device is explained as one example of display device.

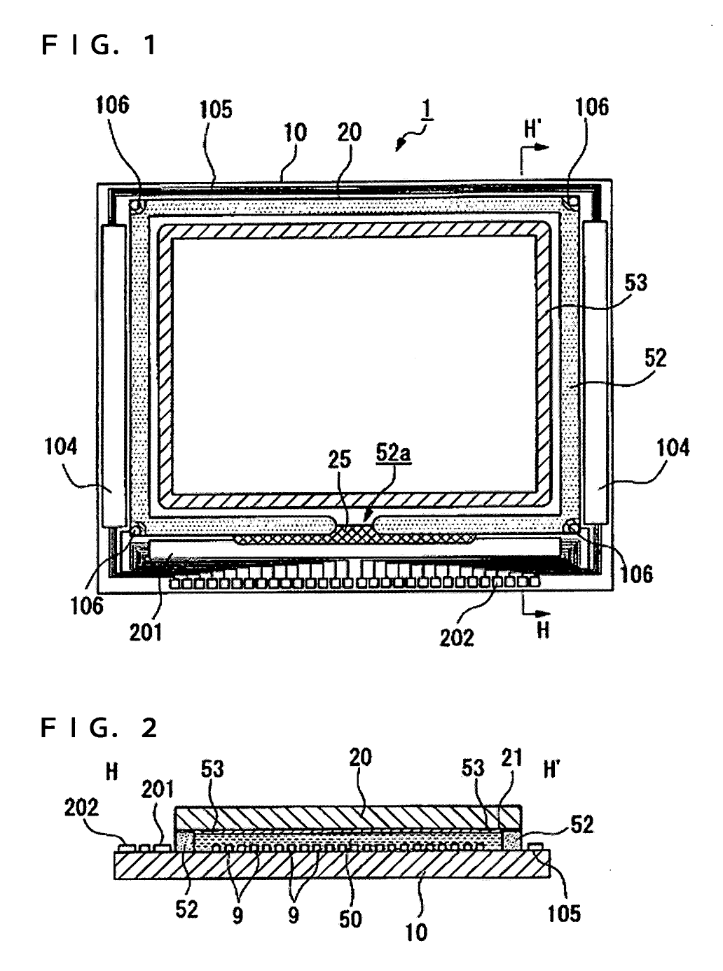

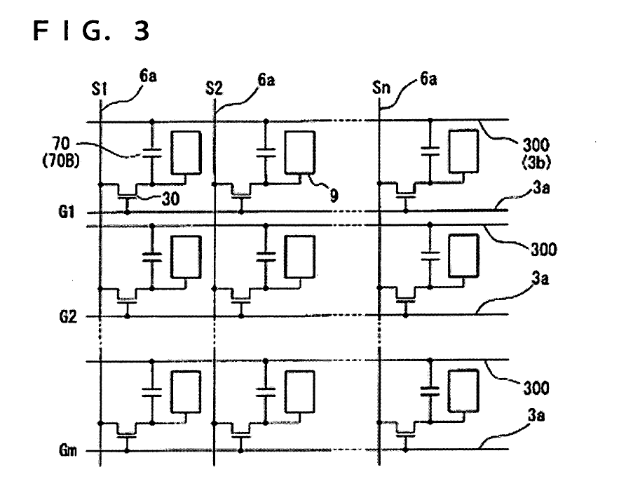

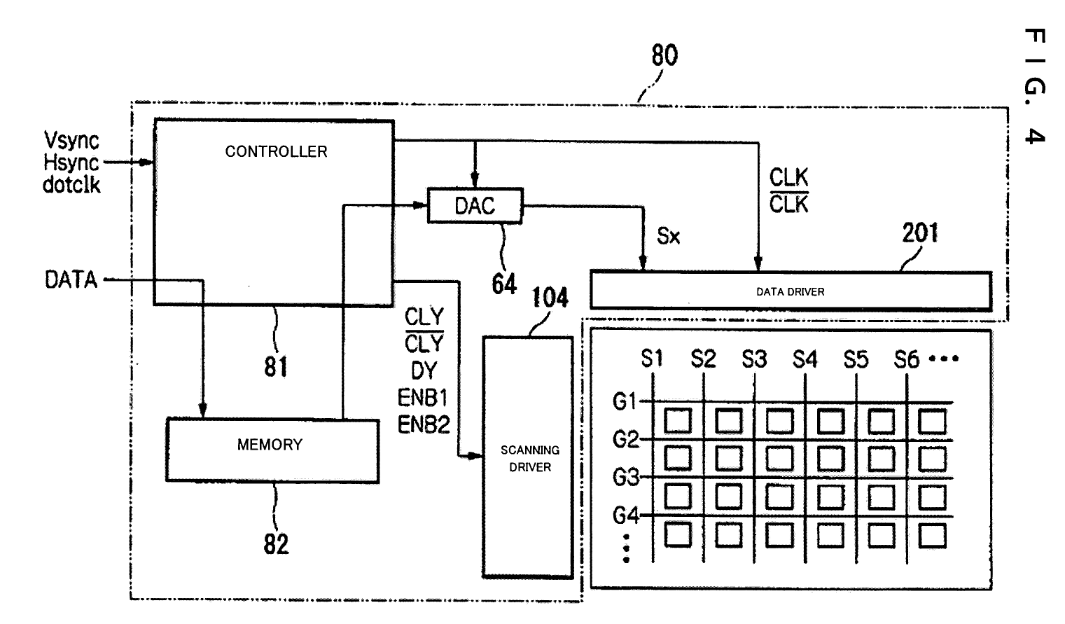

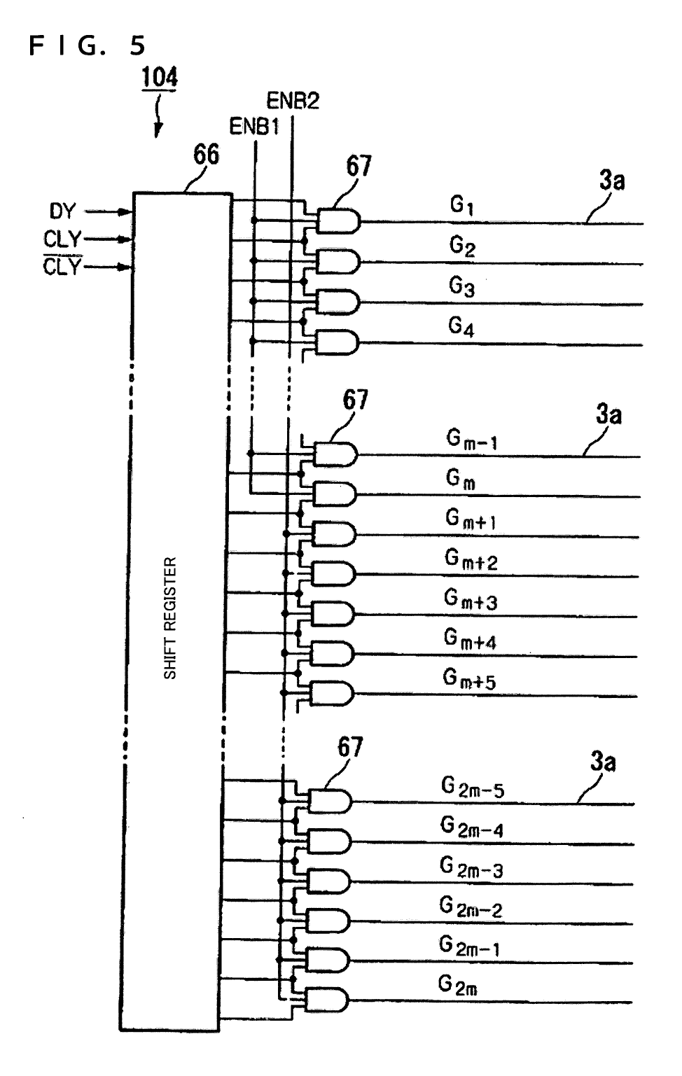

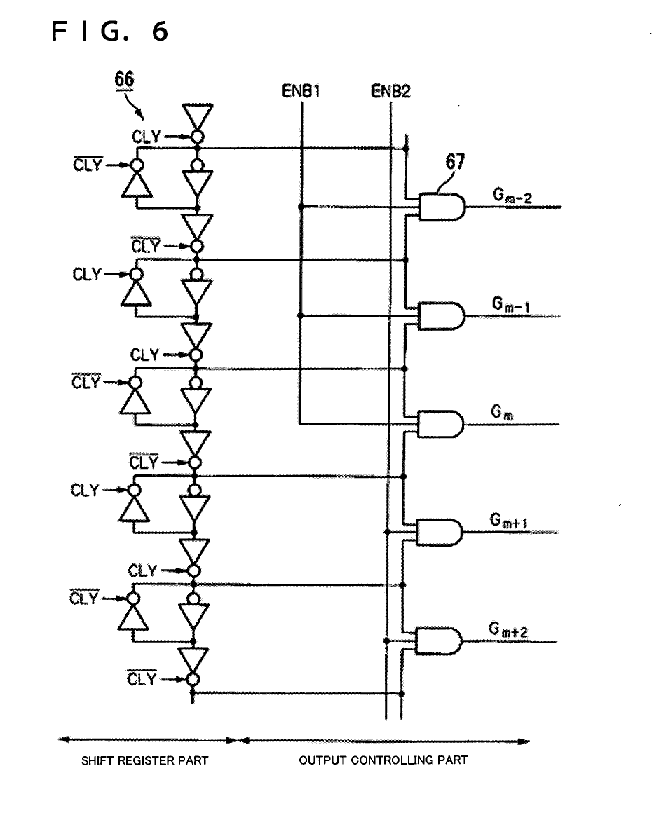

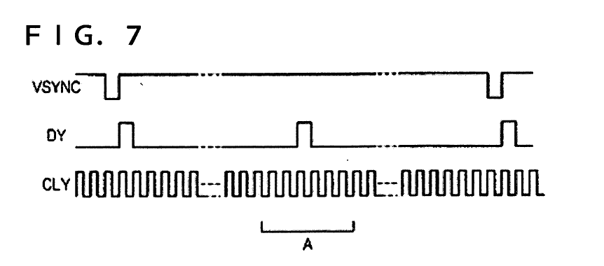

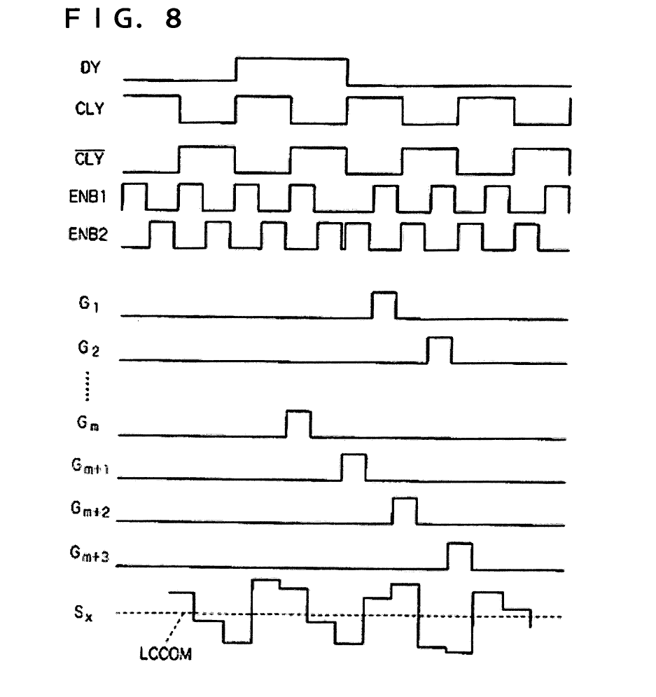

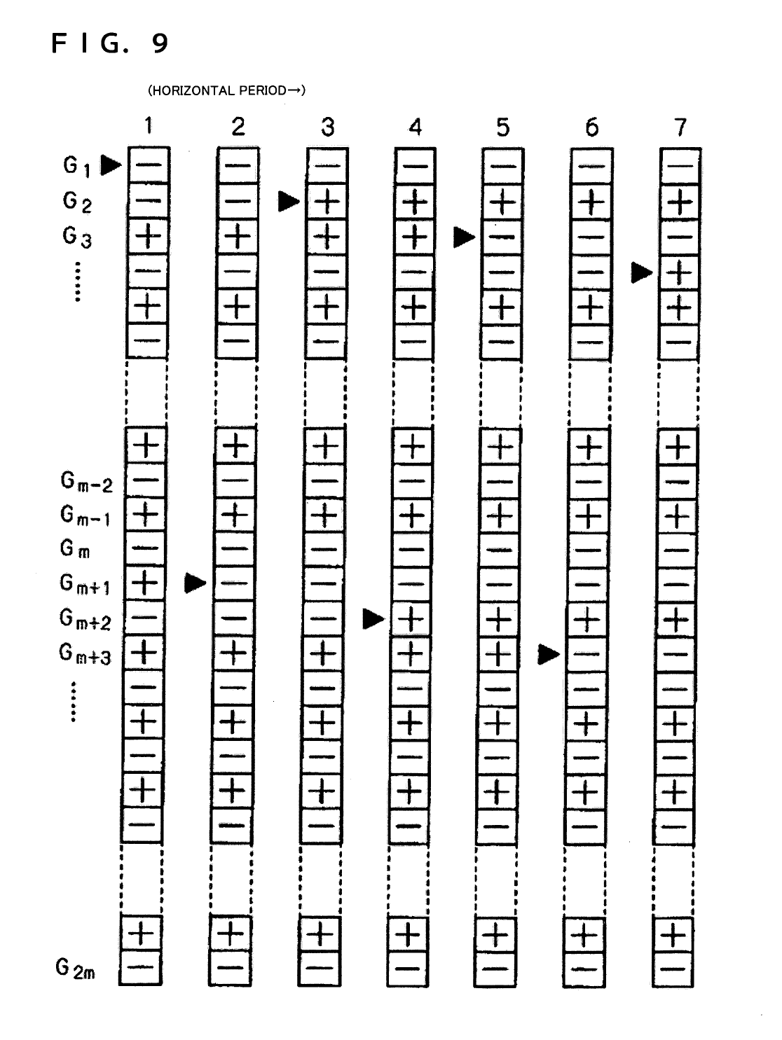

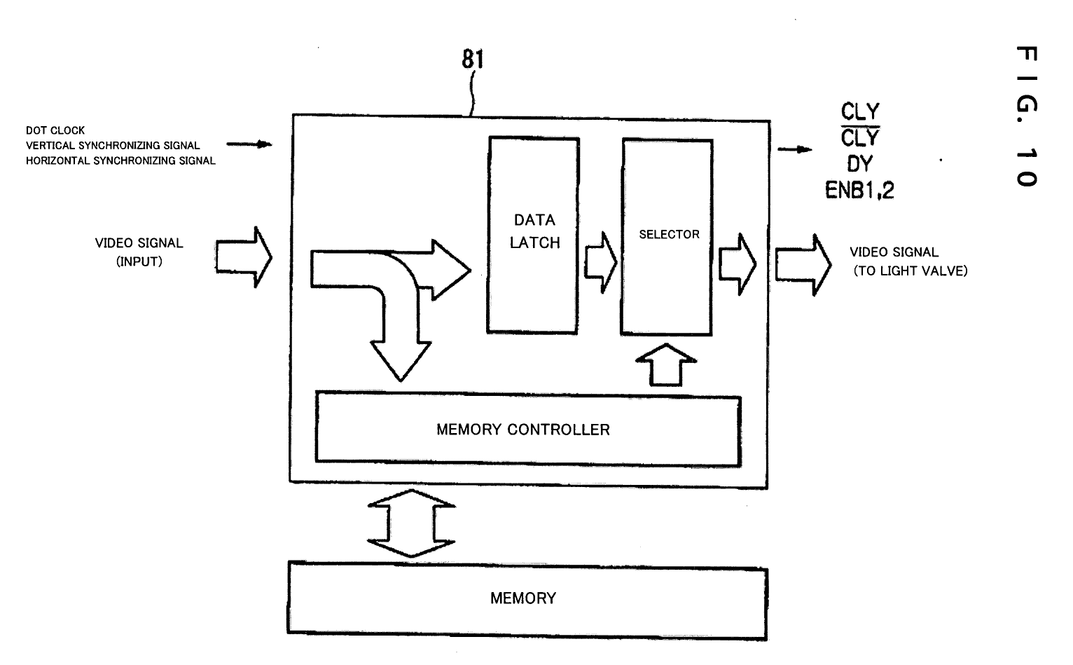

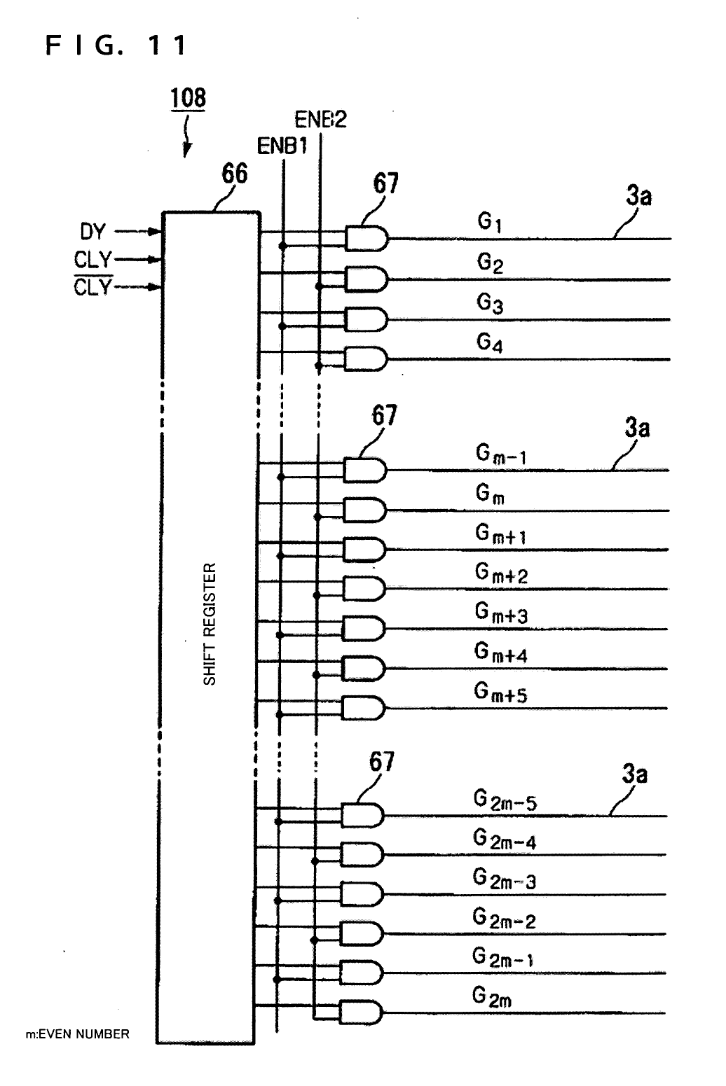

FIG. 1 is a schematic structure view of a liquid crystal display device according to a first exemplary embodiment, FIG. 2 is a cross-sectional view taken along the line H-H′ of FIG. 1, FIG. 3 is an equivalent circuit diagram showing a plurality of pixels in a matrix which forms the liquid crystal display device, FIG. 4 is an exemplary block diagram including a driving circuit, FIG. 5 is a circuit diagram showing a structure of a scanning line driving circuit, FIG. 6 is a specific circuit diagram of essential parts shown in FIG. 5, FIG. 7 is a timing chart for explaining an operation of the liquid crystal display device, FIG. 8 is a timing chart about essential parts, FIG. 9 is a view for explaining a motion in a screen, and FIG. 10 is a structure view of inside of a controller. Further, in each drawing, a reduced scale of each layer and member is varied to be recognizable in the drawings.

A structure of the liquid crystal display device is described with reference to FIGS. 1 and 2. On a TFT array substrate 10, a sealing material 52 is provided along the frame of a counter substrate 20. A light-shielding layer 53 (peripheral partition) is provided inside the sealing material as a frame. In a region outside the sealing material 52, a data driver (data line driving circuit) 201 and an external circuit connection terminal 202 is provided along one side of the TFT array substrate 10, and scanning drivers (scanning line driving circuits) 104 are provided along two sides adjacent to the side having provided with the external circuit connection terminal 202.

Further, in the remaining side of the TFT array substrate 10, a plurality of wiring lines 105 are provided in order to interconnect the scanning drivers 104 provided at both sides of an image display region. Moreover, on at least one of corners of the counter substrate 20, upper and lower conductive materials 106 are provided in order to conduct electrically between the TFT array substrate 10 and the counter substrate 20. Accordingly, as shown in FIG. 2, the counter substrate 20, which has an almost identical outline to the sealing material 52 shown in FIG. 1, is adhered to the TFT array substrate 10 via the sealing material 52. A liquid crystal layer 50 made of a TN liquid crystal is enclosed between the TFT array substrate 10 and the counter substrate 20. Further, an opening 52a formed in the sealing material 52 of FIG. 1 is a liquid crystal inlet, and is sealed by a sealant 25.

In FIG. 3, a plurality of pixels formed in a matrix, which constructs the image display region of the liquid crystal display device 1 according to the present embodiment is described. Each of the pixels has a pixel electrode 9 and a TFT 30 for switching the corresponding pixel electrode 9. A data line 6a, to which an image signal is supplied, is electrically connected to a source region of TFT 30. The liquid crystal display device 1 of this embodiment has n data lines 6a and 2m scanning lines 3a (where n and m are natural numbers). Image signals S1, S2, . . . , Sn written into the data lines 6a may be supplied line-sequentially in this order, or be supplied in a group of a plurality of data lines 6a adjacent to each other.

The scanning lines 3a are electrically connected to gates of the TFTs 30, and scanning signals G1, G2, . . . , G2m are applied to the scanning lines 3a in an interlaced manner as a pulse at a predetermined timing. By putting the TFTs 30 which are switching elements in ON state only for a given period, the image signals S1, S2, . . . , Sn supplied from the data lines 6a are written at a predetermined timing. A predetermined level of image signals S1, S2, . . . , Sn written into the liquid crystal via the pixel electrodes 9 are held between the common electrode formed on the counter substrate 20 a given period. Further, in order to prevent the leakage of the held image signals, storage capacitors are provided parallel to liquid crystal capacitors 70 formed between the pixel electrodes 9 and the common electrodes.

As shown in FIG. 4, a driving circuit 80 of the liquid crystal display device 1 of the present exemplary embodiment can include a controller 81, a memory 82, a DA converter 64 in addition to the above data driver 201 and scanning driver 104. The memory 82 temporarily stores the video input from outside as much as half screen (½ field), and generates video signals (field data) which are delayed by a ½ vertical period than the stored data. A vertical synchronized signal Vsync, a horizontal synchronized signal Hsync, a dot clock signal dotclk, and a video signal DATA are input to the controller 81 to control the memory 82. The controller 81 reads the data corresponding to the scanning lines 31 and writes data from the memory 82.

As shown in FIG. 10, the controller 81 can include a memory controller, a data latch, and selector. The DA converter 64 DA converts the image signals DATA input from the outside and image data read from the memory 82 parallel to the image signals and supplies the converted signals and data to the data driver 201. Further, the image signals DATA input from outside and the image data from the memory 82 are alternatively output for DA converter 64 for one horizontal period.

As shown in FIG. 5, the scanning driver 104 can include a shift register 66 to which a gate output pulse DY from the controller 81, a clock signal CLY, and an inversion clock signal \overline{CLY} are input, and 2m AND circuit 67 to which an output from the shift register 66 is input. The 2m scanning lines 3a are divided into two blocks by m-th and m+1-th scanning lines in the center portion as a boundary, and any of two enable signal is connected to output from the shift register 66 of each block. That is, the output from the shift register 66 and enable signal ENB 1 are input to the AND circuits 67 corresponding to the scanning lines G₁ to Gₘ, the output from shift register 66 and enable signal ENB2 are input to the AND circuits 67 corresponding to the scanning lines Gₘ₊₁ to G₂ₘ. FIG. 6 shows the inside structure of the shift register 66 in the center of the screen.

An operation of the driving circuit 80 will now be explained with reference to FIG. 7 to FIG. 9.

As shown in FIG. 7, a gate output pulse DY for one vertical period is output twice in the driving circuit 80. The gate output pulse DY shifts the shift register 66 of the scanning driver 104 by a clock signal CLY. As shown in FIG. 8 (which is an enlarged view of a portion corresponding to reference letter A in FIG. 7), when the gate output pulse DY reach a region (specifically, Gm+1-th scanning line) controlled by a different enable signal in the center of the screen, the phases of the enable signal ENB1 and the enable signal ENB2 reverse. According to the above operation, the gate pulses are alternatively output to two positions of the screen which are separated from each other by m scanning lines. That is, by interlacing from a predetermined scanning line to another scanning line separated by m scanning lines, the gate pulses return to a scanning line next to the predetermined scanning line. Further, by interlacing from the other scanning line to a scanning line separated by m scanning lines, the gate pulses return to the next scanning line. In this manner (that is, in this order of scanning line G₁, scanning _{Gm+1}, scanning line G₂, scanning line Gₘ₊₂, scanning line G₃, . . . ) the gate pulses are sequentially output.

In the meantime, the potential of data signal Sx, which is output from the data driver 201, is inversed between positive potential and negative potential with respect to the predetermined potential (for example, common potential LCCOM) every two horizontal periods. Therefore, the data signal Sx inverse its polarity every two horizontal periods, and the gate pulses are alternately output to two positions of the screen which are separated from each other by m scanning lines in the above order. As a result, as shown in FIG. 9, on the screen, the data with reversed polarity is written into the pixels connected to the adjacent scanning lines G₁ to G₂ₘ, that is, it is in a line inversion state. A pixel connected to one scanning line selected for every horizontal period is rewritten with reversed polarity. For example, the negative potential is written into the pixel corresponding to the scanning line G₁ at a first horizontal period, the negative potential is written into the pixel corresponding to the scanning line Gₘ₊₁ at a second horizontal period in which the positive potential was written at the first horizontal period. Further, for a third horizontal period, the positive potential is written into a dot corresponding to the scanning line G₂ in which the negative potential is written for the first and second periods. In this manner, the writing operations are repeated.

While the writing operation for one scanning line is synchronized with the video signal from the outside, the writing operation for another scanning line must be performed. Thus, the writing vertical period must be half of the horizontal period of the video signal input from the outside. In order to fulfill the above, a latch circuit as one line is provided in the data driver 201, a data line keeps one line, and then the data is transmitted to the data driver 201 at multiple speed. With respect to the data read from the memory 82, it is possible to increase the speed of writing by reading rapidly from the memory 82.

That is to say, in the method for writing data according to the present embodiment, one frame data is divided into a first field data to which an image signal is directly written into the pixel and second field data which is read out after storing in the memory 82, the first and second field data are shifted by a ½ vertical period to be overwritten, thus to be equivalent. For this reason, all of the scanning lines are scanned while some part (plural) of scanning line is interleaved and gone back and forth.

In the liquid crystal display device according to the present embodiment, the image data is written in every line by the image signal from the outside, and the image data is written by the image data read from the memory 82. Therefore, as shown in FIG. 8, a multiple scanning is performed by writing two lines in one pulse of the clock signal CLY. In contrast, in the case of conventional multiple scanning, memories for two fields are needed. But, in this structure, the image signal from the outside is directly output to the data line to write only for half screen. Therefore, the required memory capacity is only half capacity for whole screen. Thus, the data storage capacity may only ¼ of the conventional data storage capacity such that it is possible to simplify the structure of the display device and to significantly reduce the manufacturing cost of the display device. According to the display device of the present structure, since the multiple speed scanning and the line inversion are performed with respect to pixels, it is possible to prevent the generation of flicker and crosstalk to improve the display quality.

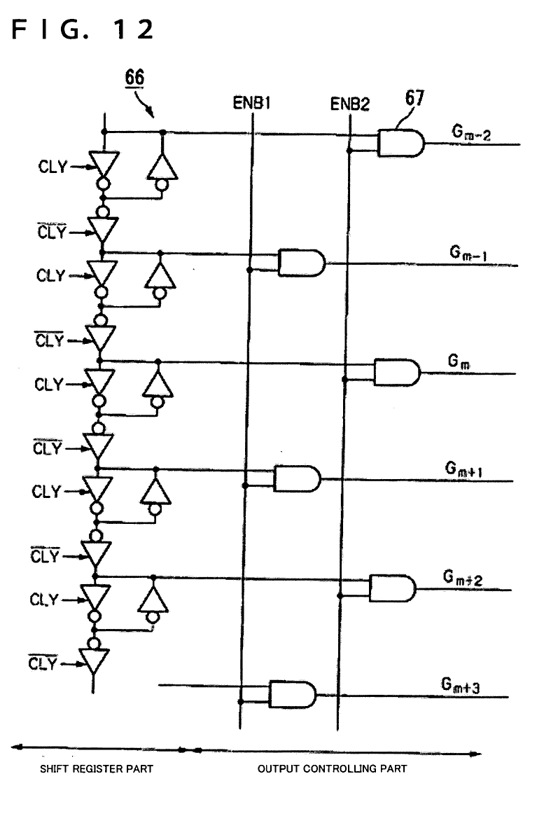

Hereinafter, a second exemplary embodiment of the invention is explained with reference to FIG. 11 to FIG. 13. A liquid crystal driver (liquid crystal device) according to the embodiment has an almost identical structure as the first embodiment, except the shape of the scanning driver.

As shown in FIG. 11, the scanning driver 108 can include a shift register 66 to which gate output pulse DY from a controller 81, a clock signal CLY, and an inversion clock signal CLY′ are input, and 2m AND circuit 67 to which output from the shift register 66 is input. 2m scanning lines 3a are divided into two blocks in which one is arranged in the odd numbered order from the uppermost of an image display region, and another is arranged in the even numbered order, and any of two enable signal is connected to output from the shift register of each block. Accordingly, the output from the shift register 66 and the enable signal ENB1 are input to the AND circuit 67 corresponding to even numbered scanning lines G₂, G₄, . . . , Gₘ, Gₘ₊₂, G₂ₘ, and output from the shift register 66 and the enable signal ENB2 are input to the AND circuit 67 corresponding to odd numbered scanning lines G₁, G₃, . . . , Gₘ₊₁, Gₘ₊₃, . . . , G₂ₘ₊₁. FIG. 12 shows the inside structure of the shift register 66 in the center of the screen.

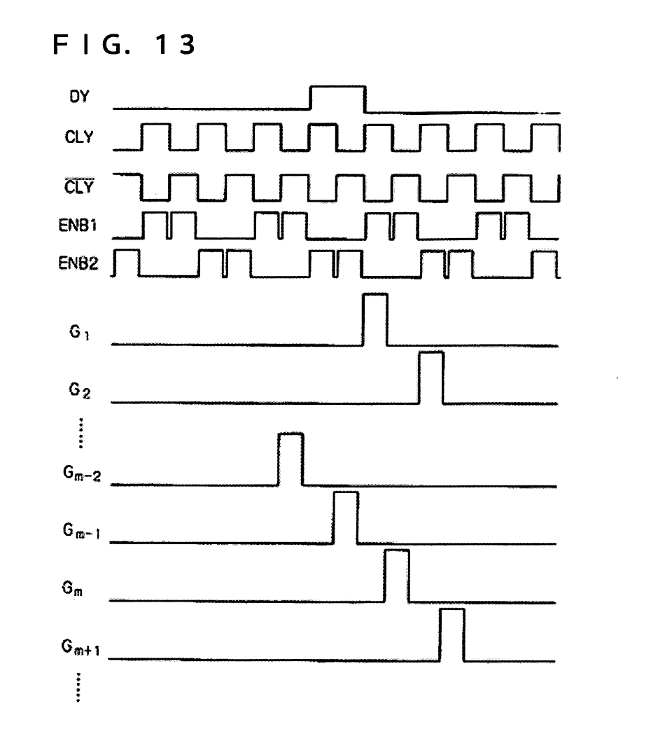

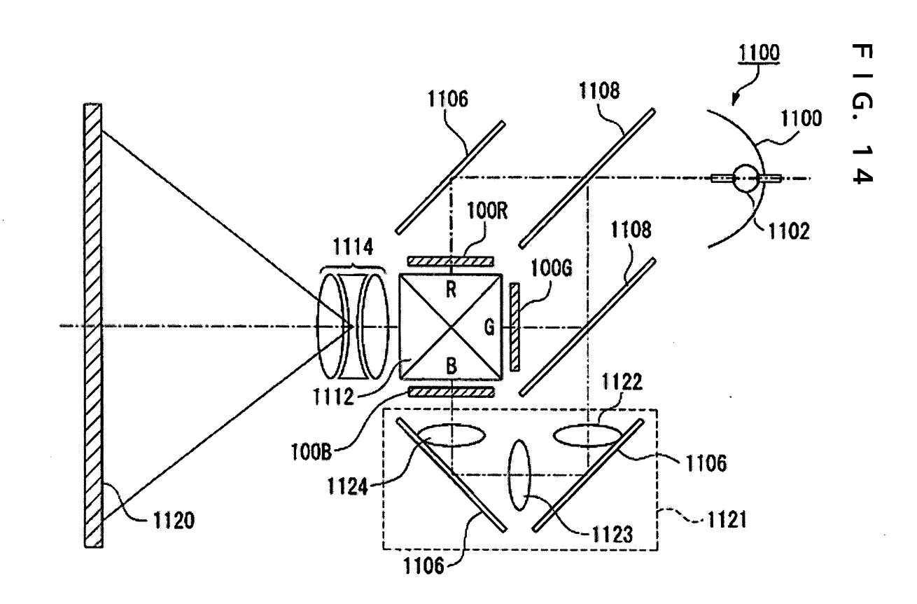

An operation of the driving circuit will now be explained with reference to FIG. 13. A gate output pulse DY for one vertical period is output twice in the driving circuit 80. The gate output pulse DY shifts the shift register 66 of the scanning driver 108 by a clock signal CLY. In the meantime, the enable signals ENB1, ENB2 are generated alternatively in every two horizontal periods, in this order, ENB1, ENB1, ENB2, ENB2, ENB1, ENB1, ENB2, ENB2. A scanning signal is output to a scanning line corresponding to the position where the enable signals are generated. By the above operation, the gate pulses are alternatively output at two positions of the screen which are separated from each other by m scanning lines. That is, by interlacing from a predetermined scanning line to another scanning line separated by m scanning lines, the gate pulses return to a scanning line next to the predetermined scanning line. Further, by interleaving from the other scanning line to a scanning line separated by m scanning lines, the gate pulses return to the next scanning line. In this manner (that is, in this order of scanning line G₁, scanning Gₘ₊₁, scanning line G₂, scanning line Gₘ₊₂, scanning line G₃, . . . ), the gate pulses are sequentially output.

In the meantime, the potential of data signal Sx, which is an output from the data driver 201, is inversed between the positive potential and negative potential with respect to a predetermined potential (for example, common potential LCCOM) in every two horizontal period. Therefore, the data signal Sx inverses its polarity in every two horizontal period, and the gate pulses are alternately output to two positions of the screen which are separated from each other by m scanning lines in the above order. As a result, as shown in FIG. 9, on the screen, the data with reversed polarity is written into the pixels connected to the adjacent scanning lines G₁ to G₂ₘ, that is, it is in the line inversion state. A pixel connected to one scanning line selected for every horizontal period is rewritten with reversed polarity. That is, in the exemplary embodiment, the same scanning as the first embodiment is performed, excepting the manner of generating enable signals.

Therefore, in the liquid crystal display device according to the present embodiment, by performing a multiple speed scanning using the memory 82, the required memory capacity is decreased while the structure of the device is simplified. As a result, it is possible to obtain the same effect as the first embodiment, that is, it is possible to reduce the manufacturing cost, to prevent flicker and crosstalk, and to improve the display quality.

FIG. 14 is a schematic view showing an example of a three-plate projection liquid crystal display device (liquid crystal projector) that uses three liquid crystal light valves according to the above embodiment. In the drawing, reference numeral 1100 represents a light source, reference numeral 1108 represents a dichroic mirror, reference numeral 1106 represents an inversion mirror, and 1122, 1123, 1124 represent relay lenses, reference numeral 100R, 100G, 100B represent liquid crystal light valves, reference numeral 1112 represents cross-dichroic prisms, and reference numeral 114 represents projection lens system.

The light source 1100 can include a lamp 1102 such as a metal halide, and a reflector 1101 for reflecting light from the lamp 1102. The dichroic mirror 1108 for reflecting a blue light component and a green light component transmits a red light component among white light component from the light source 1100 and reflects the blue light component and the green light component. The transmitted red light component is reflected on the reflective mirror 1106, and enters the liquid crystal light valve 100R for a red light component.

The green light component among the color light components reflected on the dichroic mirror 1108 is reflected on the dichroic mirror for reflecting the green light component and enters the liquid crystal light valve 100G as the green light component. Further, the blue light component is also transmitted by the second dichroic mirror 1108. With respect to the blue light component, in order to compensate the difference in length from the green light component and the red light component, light guiding device 1121 comprising the incident lens 1122, relay lens 1123, and emitting lens 1124. The blue light component enters the liquid crystal display device 100B for the blue light component through the light guiding device 1121.

Three color light components modified by the light valves 100R, 100G, and 100B enters the cross dichroic prism 1112. The prism is made by bonding four rectangular prisms. Inside the prism, a dielectric multilayered film for reflecting the red light component and a dielectric multilayered film for reflecting the blue light component are formed in a cross-shape. The three color light components are combined to generate light representing color images. The combined light components are projected onto the screen 1120 by the projection lens system 1114 such as a projection optical system, and thus the images are magnified.

In the projection display device having the above structure, it is possible to provide the projection liquid crystal display device having an excellent uniformity in display by using the liquid crystal light valve of the above exemplary embodiment.

It should be understood that the technical scope of the invention is not limited to the above embodiments and various changes may be made without departing from the spirit and scope of the invention. For example, in the above embodiment, an active matrix type liquid crystal display device using the TFTs is explained as an example, but the present invention is not limited thereto. It is possible to use TFD (Thin Film Diode) as the pixel switching element, or a passive matrix type display device. Further, it is possible to apply the present invention to several types of display devices for matrix-driving a plurality of pixels, other than the liquid crystal device, for example, an organic EL display device. In this case, it is possible to increase the number of light emitting for a limited time by performing a multiple speed scanning without using a high capacity memory. Further, it is effective in improving the brightness for the image and reducing the power consumption while providing the same brightness as the related display devices.

1. A display device, comprising:
a plurality of data lines and a plurality of scanning lines which intersect each other;
pixels electrically coupled to the plurality of data lines and the plurality of scanning lines;
a data-line driving circuit that supplies, to the plurality of data lines, image signals whose polarities are inversed between positive potential and negative potential with respect to a predetermined potential at predetermined intervals; and
a scanning-line driving circuit that supplies, to the plurality of scanning lines, pulse signals which are generated at different time intervals for one horizontal period, while interleaving some parts of the plurality of scanning lines;
the data-line driving circuit further including a data storing device capable of storing input data for a specified period, and the data-line driving circuit writes image signals input into the pixels as first field data, generates second field data delayed with respect to the first field data, by reading the image signals after storing the image signals into the data storing device, and writes alternately the first field data and the second field data in the pixels coupled to the scanning lines to which the pulse signals are supplied while interleaving for every horizontal period.

2. The display device according to claim 1, the data-line driving circuit supplying image signals whose polarities are inversed between positive potential and negative potential with respect to a predetermined potential every two horizontal periods, the scanning line driving circuit supplying the plurality of pulse signals to the plurality of data lines while interleaving some of the plurality of scanning lines such that the image signals which have an inversed polarity are written into the pixels coupled to the adjacent scanning lines, and performing line-inversion driving.

3. The display device according to claim 2, when a number of scanning lines is 2m, the scanning line driving circuit supplying the pulse signal generated at the timing corresponding to a period in which the positive polarity potential is applied to a predetermined scanning line, supplying the pulse signal generated at the timing corresponding to a period in which the positive polarity potential is applied to the scanning line separated from the predetermined scanning line by m, supplying the pulse signal generated at the timing corresponding to a period in which negative polarity potential is applied to the scanning line next to the predetermined scanning line, supplying the pulse signal generated at the timing corresponding to a period in which the negative polarity potential is applied to the scanning line remote from the scanning line next to the predetermined scanning line by m, and repeating the above-described operations such that the image signals having different polarities are written into the pixels corresponding to the adjacent scanning lines.

4. The display device according to claim 1, the scanning line driving circuit alternately shifting two gate output pulses to adjacent scanning lines by synchronizing with a shift clock signal, and assigning one of the two alternately generated enable signals to each scanning line such that an output of the scanning signals to respective scanning lines is controlled.

5. The display device according to claim 4, the scanning line driving circuit outputting the two gate output pulses to the scanning line driving circuit so as to be separated from each other by a distance corresponding to ½ of a vertical period, and assigns one of the first enable signal and the second enable signal that are alternately generated to each scanning line,
when the image display region is divided into a first display region and a second display region from an upper end in a direction in which the scanning lines are arranged, respective enable signals are assigned to the plurality of scanning lines arranged in any one of the first and second display regions, and
the scanning signals being alternately output to the scanning line that belongs to the first display region and to the scanning line that belongs to the second display region corresponding to the position where each enable signal is generated.

6. The display device according to claim 4,
the scanning driving circuit outputting the two gate output pulses to a position that is separated from each other by a distance corresponding to ½ of a vertical period, and assigning one of the first enable signal and the second enable signal that are alternately generated to each scanning line,
the first enable signal and the second enable signal being assigned to odd numbered scanning lines and to even numbered scanning lines, respectively, from a leftmost portion of the image display region, and
the image display region being divided into the first display region and the second display region from an upper end in a direction in which the scanning lines are arranged, and the scanning signals being alternately output to the scanning line that belongs to the first display region and to a scanning line that belongs to the second display region corresponding to a starting position of each enable signal.

7. A display device, comprising:
a plurality of data lines and a plurality of scanning lines which intersect each other;
pixels electrically coupled to the plurality of data lines and the plurality of scanning lines;
a data-line driving circuit that supplies, to the plurality of data lines, image signals whose potentials are inversed between higher potential and lower potential with respect to a predetermined potential at predetermined intervals; and
a scanning-line driving circuit that supplies, to the plurality of scanning lines, pulse signals which are generated at different time intervals for one horizontal period, while interleaving some parts of the plurality of scanning lines;
the data-line driving circuit including a data storing device capable of storing input data for a specified period, and the data-line driving circuit writes image signals input into the pixels as first field data, generates second field data delayed with respect to the first field data, by storing the image signals into the data storing device, and writes alternately the first field data and the second field data in the pixels coupled to the scanning lines to which the pulse signals are supplied while interleaving for every horizontal period.

8. A method of driving a display device having a plurality of data lines and a plurality of scanning lines that intersect each other, and pixels coupled to the data lines and the scanning lines, the method comprising:
supplying, to the plurality of data lines at predetermined intervals, image signals whose polarities are inversed between positive polarity potential and negative polarity potential with respect to predetermined potential;
supplying a plurality of pulse signals generated at different timings to the plurality of scanning lines every horizontal period while interleaving part of the plurality of scanning lines;
writing the image signals input in the pixels using data storage device that stores input data for a specified time as first field data;
generating second field data delayed with respect to the first field data by reading the image signals after storing the image signals in the data storage device; and
alternately writing the first field data and the second field data in the pixels coupled to the scanning lines to which the pulse signals are supplied while interleaving every horizontal period.

9. The method of driving a display device according to claim 7, an interlaced scanning of the scanning lines being performed for a vertical period at a frequency of no less than 100 Hz.

10. A projection display device, comprising an illumination device, a light modulating device that modulates light emitted from the illumination device, and a projector that projects the light modulated by the light modulating device,
the display device according to claim 1 being used as the light modulating device.
